(19) United States
(12) Patent Application Publication
(10) Pub. No.: US 2012/0055624 A1
(43) Pub. Date: Mar. 8, 2012

(54) System and Method for Manufacturing Co-extruded Plastic Film and Products Using Same

(76) Inventor: Robert D. Bailey, Long Beach, CA (US)

(21) Appl. No.: 12/875,112

(22) Filed: Sep. 2, 2010

(51) Int. Cl. B29C 47/06

(52) U.S. Cl. 156/244.24

(57) ABSTRACT

The invention relates generally to the field of plastics manufacturing. In particular, but not by way of limitation, the invention relates to a system and method for manufacturing co-extruded plastic film and products using same. In one embodiment, a first plastic layer having a relatively high melting temperature is co-extruded with a second plastic layer having a relatively low melting temperature. Embodiments of the invention also disclose manufacturing processes for end products that exploit the improved co-extruded film. One embodiment is a process for manufacturing a bag stack with releasable bonds between adjacent bags in the bag stack. Another embodiment is a process for manufacturing a stack of plastic sheets with releasable bonds between adjacent sheets in the sheet stack.

### FIELD OF INVENTION

The invention relates generally to the field of plastics manufacturing. In particular, but not by way of limitation, the invention relates to a system and method for manufacturing co-extruded plastic film and products using same.

### BACKGROUND

Consumable thermoplastic (plastic) products, such as polyethylene bags and sheets, are often sold in stacks. The stack format facilitates distribution, and also allows a consumer to individually dispense a bag or sheet as needed. For instance, a bag stack may be suspended from a rack near the point of sale in a retail store, and bags can be individually separated from the stack.

Discrete dispensing requires that each item can be easily separated from the stack. While perforated attachment, for example to a stack header, is often acceptable, some applications require a releasable bond between adjacent bags or sheets. Many plastic welding techniques are known. But conventional processes that form releasable bonds are often difficult to control during manufacturing.

Improved materials and/or manufacturing processes are needed for forming releasable plastic bonds.

### SUMMARY OF THE INVENTION

Embodiments of the invention seek to overcome one or more of the limitations described above. In one embodiment, a first plastic layer having a relatively high melting temperature is co-extruded with a second plastic layer having a relatively low melting temperature. During manufacturing of a stack of bags, sheets, or other plastic products, a releasable bond can be formed between at least portions of adjacent second plastic layers without bonding adjacent first plastic layers.

In a first embodiment, the first plastic layer of a co-extruded material is high-density polyethylene (HDPE) and the second plastic layer is ethylene vinyl acetate (EVA) or ethylene methyl acrylate (EMA). In a second embodiment of the invention, the first plastic layer is a blend of HDPE and linear low density polyethylene (LLDPE), and the second plastic layer is EVA or EMA. In a third embodiment, the first plastic layer of a co-extruded material is HDPE or a HDPE/LLDPE blend and the second plastic layer is a blend of LLDPE and polyolefin plastomer (POP). In a fourth embodiment, the first plastic layer of a co-extruded material is HDPE or a HDPE/LLDPE blend and the second plastic layer is a blend of HDPE and POP. In a variation of the third or fourth embodiment, a polyolefin elastomer (POE) could be used in place of the POP. Alternatively, in a variation of the third or fourth embodiment, the second layer is POP only.

Embodiments of the invention also disclose manufacturing processes for end products that exploit the improved co-extruded film. One embodiment is a process for manufacturing a bag stack with releasable bonds between adjacent bags in the bag stack. Another embodiment is a process for manufacturing a stack of plastic sheets with releasable bonds between adjacent sheets in the sheet stack.

These and other features are more fully described in the detailed description section.

### BRIEF DESCRIPTION OF THE DRAWINGS

Embodiments of the invention are described with reference to the following drawings, wherein:

FIG. 1A is a flow diagram of a co-extrusion process with reference to functional manufacturing components, according to an embodiment of the invention;

FIG. 1B is a flow diagram of a co-extrusion process with reference to functional manufacturing components, according to an embodiment of the invention;

FIG. 2A is a flow diagram of a co-extrusion process with reference to functional manufacturing components, according to an embodiment of the invention;

FIG. 2B is a flow diagram of a co-extrusion process with reference to functional manufacturing components, according to an embodiment of the invention;

FIG. 3 is a flow diagram of a bag stack manufacturing process, according to an embodiment of the invention;

FIG. 4 is a perspective view of a bag stack, according to an embodiment of the invention;

FIG. 5 is a flow diagram of a sheet stack manufacturing process, according to an embodiment of the invention;

FIGS. 6A-6C are side sectional views of a sheet stack before and during a dispensing operation, according to an embodiment of the invention; and

FIGS. 7A-7D are perspective views of a dispensing container for a sheet stack before and during a dispensing operation, according to an embodiment of the invention.

### DETAILED DESCRIPTION

The drawings are not to scale. Some features illustrated in the drawings have been exaggerated for descriptive clarity. Sub-headings are used in this section for organizational convenience; the disclosure of any particular feature(s) is/are not necessarily limited to any particular section or sub-section of this specification. The detailed description begins with the co-extrusion process.

### Plastic Film Co-Extrusion

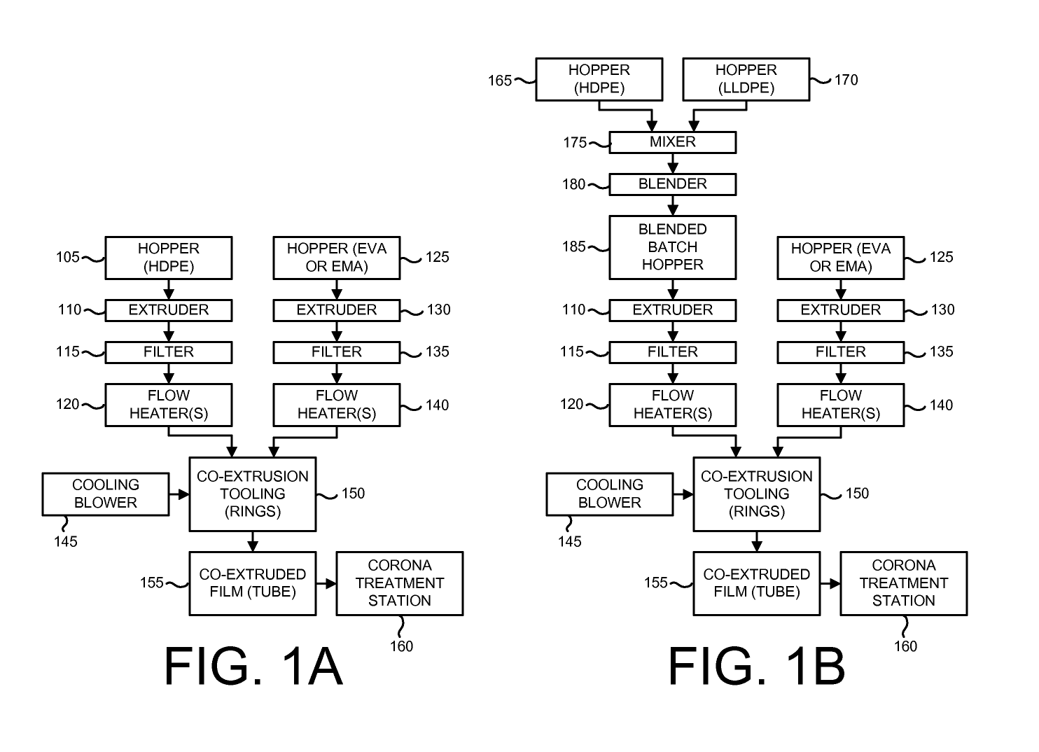

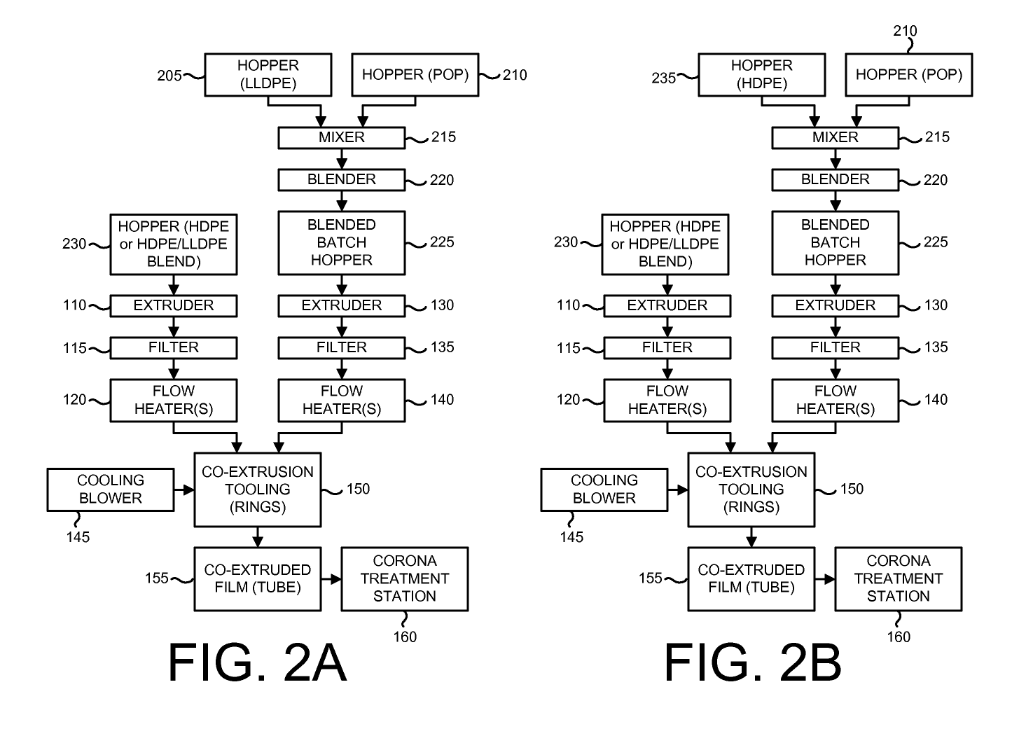

FIGS. 1A, 1B, 2A, and 2B illustrate four alternative processes for producing co-extruded film with a first plastic layer having a relatively high melting temperature and a second plastic layer having a relatively low melting temperature.

FIG. 1A is a flow diagram of a co-extrusion process with reference to functional manufacturing components, according to an embodiment of the invention. As shown therein, high-density polyethylene (HDPE) pellets are fed from the hopper 105 to the extruder 110. The extruder 110 meters the input of HDPE pellets, melts, mixes, and pumps liquefied HDPE through the filter 115 and flow heater(s) 120 to the co-extrusion tooling 150. Likewise, ethylene vinyl acetate (EVA) or ethylene methyl acrylate (EMA) pellets are fed from the hopper 125 to the extruder 130. The extruder 130 meters the input of EVA or EMA pellets, melts, mixes, and pumps liquefied EVA or EMA through the filter 135 and flow heater(s) 140 to the co-extrusion tooling 150. The co-extrusion tooling 150 also receives cold air from the cooling blower 145, and outputs co-extruded film 155. The co-extrusion tooling 150 is preferably in the form of concentric rings, and the co-extruded film 155 is preferably in the form of blown film (tube) to achieve the desired material thicknesses. The co-extruded film 155 includes HDPE on an inner layer, and EVA or EMA on an outer layer. The co-extruded film 155 may then be treated at the corona treatment station 160 to improve adhesion at subsequent welding and/or printing steps.

The melting points of HDPE, EVA, and EMA are approx. 266, 176, and 216 deg. F., respectively. Because the melting temperatures of EVA and EMA are lower than the melting temperature of HDPE, it may be easier to produce releasable bonds between adjacent EVA or EMA layers during subsequent manufacturing without bonding adjacent HDPE layers. In embodiments of the invention, the HDPE layer of the co-extruded film 155 is much thicker than the EVA or EMA layer. For instance, the HDPE layer may be 5 to 300 microns (micrometers) thick, whereas the EVA or EMA layer may only be 1 to 60 microns thick. In other words, the thickness of the inner HDPE layer may be five times the thickness of the outer EVA or EMA layer. Other thickness ratios are also possible. The relative thickness of the EVA or EMA layer enables bonds between adjacent EVA or EMA layers to be predictably released according to application requirements.

Variations to the process illustrated in FIG. 1A are possible. For example, in embodiments of the invention, hoppers 105 and/or 125 may also include recycled polymeric material, filler, color concentrate, and/or other additives without changing the principle process flow and benefits that are described above with reference to FIG. 1A.

FIG. 1B is a flow diagram of a co-extrusion process with reference to functional manufacturing components, according to an embodiment of the invention. The process flow is the same as the embodiment in FIG. 1A except as described below. HDPE pellets are fed from hopper 165 to the mixer 175. Likewise, linear low density polyethylene (LLDPE) pellets are fed from hopper 170 to the mixer 175. The mixer 175 mixes the HDPE and the LLDPE; and then the blender 180 blends the HDPE and the LLDPE into a predetermined HDPE/LLDPE blend. The HDPE/LLDPE blend may be stored in the blended batch hopper 185 before it is fed to the extruder 110. The HDPE/LDPE blend may be preferable to HDPE alone due to improved material flow characteristics and/or other properties. The co-extruded film 155 includes an HDPE/LLDPE blend on an inner layer, and EVA or EMA on an outer layer.

The melting points of HDPE, LLDPE, EVA, and EMA are approx. 266, 248, 176, and 216 deg. F., respectively. Because the melting temperatures of EVA and EMA are lower than the melting temperature of the HDPE/LLDPE blend, it may be easier to produce releasable bonds between adjacent EVA or EMA layers during subsequent manufacturing without bonding adjacent HDPE/LLDPE blend layers. In embodiments of the invention, the HDPE/LLDPE blend layer of the co-extruded film 155 is much thicker than the EVA or EMA layer. For instance, the HDPE/LLDPE blend layer may be 5 to 300 microns (micrometers) thick, whereas the EVA or EMA layer may only be 1 to 60 microns thick. In other words, the thickness of the inner HDPE/LLDPE blend layer may be five times the thickness of the outer EVA or EMA layer. Other thickness ratios are also possible. The relative thickness of the EVA or EMA layer enables bonds between adjacent EVA or EMA layers to be predictably released according to application requirements.

Variations to the process illustrated in FIG. 1B are possible. For instance, in embodiments of the invention, hoppers 165, 170 and/or 125 may also include recycled polymeric material, filler, color concentrate, and/or other additives without changing the principle process flow and benefits that are described above with reference to FIG. 1B.

FIG. 2A is a flow diagram of a co-extrusion process with reference to functional manufacturing components, according to an embodiment of the invention. The process flow is the same as the embodiment in FIG. 1A except as described below. HDPE or a HDPE/LLDPE blend is disposed in hopper 230 and fed to the extruder 110. Linear low density polyethylene (LLDPE) pellets are fed from hopper 205 to the mixer 215. Likewise, polyolefin plastomer (POP) pellets are fed from hopper 210 to the mixer 215. The POP pellets may be, for example, Dow Affinity™ POP. The mixer 215 mixes the LLDPE and the POP; and then the blender 220 blends the LLDPE and the POP into a predetermined LLDPE/POP blend. The LLDPE/POP blend may be stored in the blended batch hopper 225 before it is fed to the extruder 130. The co-extruded film 155 includes HDPE or an HDPE/LLDPE blend on an inner layer, and a LLDPE/POP blend on an outer layer.

The melting points of HDPE, LLDPE, and pure POP are approx. 266, 248, and 133 deg. F., respectively. Because the melting temperature of the LLDPE/POP blend is lower than the melting temperature of HDPE or an HDPE/LLDPE blend, it may be easier to produce releasable bonds between adjacent LLDPE/POP blend layers during subsequent manufacturing without bonding adjacent HDPE or HDPE/LLDPE blend layers. The LLDPE/POP blend may be preferable to EVA or EMA (discussed with reference to FIGS. 1A and 1B) due to lower material costs or other material properties. The LLDPE may be, for example, 0-90% of the LLDPE/POP blend, and the POP may be 10-100% of the LLDPE/POP blend. In embodiments of the invention, the HDPE or HDPE/LLDPE blend layer of the co-extruded film 155 is much thicker than the LLDPE/POP blend layer. For instance, the HDPE or HDPE/LLDPE blend layer may be 5 to 300 microns (micrometers) thick, whereas the LLDPE/POP blend layer may only be 1 to 60 microns thick. In other words, the thickness of the inner HDPE or HDPE/LLDPE blend layer may be five times the thickness of the outer LLDPE/POP blend layer. Other thickness ratios are also possible. The relative thickness of the LLDPE/POP blend layer enables bonds between adjacent LLDPE/POP blend layers to be predictably released according to application requirements.

Variations to the process illustrated in FIG. 2A are possible. For instance, an alternative POP material or a polyolefin elastomer (POE) could be used in place of the Dow Affinity™ POP, according to design choice. In an alternative embodiment, the outer layer could be POP alone. In addition, hoppers 230, 205 and/or 210 may also include recycled polymeric material, filler, color concentrate, and/or other additives without changing the principle process flow and benefits that are described above with reference to FIG. 2A.

FIG. 2B is a flow diagram of a co-extrusion process with reference to functional manufacturing components, according to an embodiment of the invention. The process flow is the same as the embodiment in FIG. 1A except as described below. HDPE or a HDPE/LLDPE blend is disposed in hopper 230 and fed to the extruder 110. HDPE pellets are fed from hopper 235 to the mixer 215. Likewise, POP pellets are fed from hopper 210 to the mixer 215. The POP pellets may be, for example, Dow Affinity™ POP. The mixer 215 mixes the HDPE and the POP; and then the blender 220 blends the HDPE and the POP into a predetermined HDPE/POP blend. The LLDPE/POP blend may be stored in the blended batch hopper 225 before it is fed to the extruder 130. The co-extruded film 155 includes HDPE or an HDPE/LLDPE blend on an inner layer, and a HDPE/POP blend on an outer layer.

The melting points of HDPE and pure POP are approx. 266 and 133 deg. F., respectively. Because the melting temperature of the HDPE/POP blend is lower than the melting temperature of HDPE or a HDPE/LLDPE blend, it may be easier to produce releasable bonds between adjacent HDPE/POP blend layers during subsequent manufacturing without bonding adjacent layers of HDPE. The HDPE/POP blend may be preferable to EVA or EMA (discussed with reference to FIGS. 1A and 1B) due to lower material costs or other material properties. The HDPE may be, for example, 0-90% of the HDPE/POP blend, and the POP may be 10-100% of the HDPE/POP blend. In embodiments of the invention, the HDPE or HDPE/LLDPE blend layer of the co-extruded film 155 is much thicker than the HDPE/POP blend layer. For instance, the HDPE or HDPE/LLDPE blend layer may be 5 to 300 microns (micrometers) thick, whereas the HDPE/POP blend layer may only be 1 to 60 microns thick. In other words, the thickness of the inner HDPE or HDPE/LLDPE blend layer may be five times the thickness of the outer LLDPE/POP blend layer. Other thickness ratios are also possible. The relative thickness of the HDPE/POP blend layer enables bonds between adjacent HDPE/POP blend layers to be predictably released according to application requirements.

Variations to the process illustrated in FIG. 2B are possible. For instance, an alternative POP material or a polyolefin elastomer (POE) could be used in place of the Dow Affinity™ POP, according to design choice. In an alternative embodiment, the outer layer could be POP alone. In addition, hoppers 230, 235 and/or 210 may also include recycled polymeric material, filler, color concentrate, and/or other additives without changing the principle process flow and benefits that are described above with reference to FIG. 2B.

### Bag Stack Manufacturing

The co-extruded film described above with reference to FIGS. 1A, 1B, 2A, and 2B improves the ability to form releasable plastic bonds between the relatively low melting temperature layers. In bag stack manufacturing applications, it is sometimes desirable to form releasable bonds between adjacent bags in the bag stack. For instance, where a welded releasable bond exists between the back of a first bag and the front of a second bag in a suspended bag stack, removing the first bag from the bag stack will cause the second bag to open in preparation for loading. This may be desirable, for example, to speed checkout at a retail point of sale.

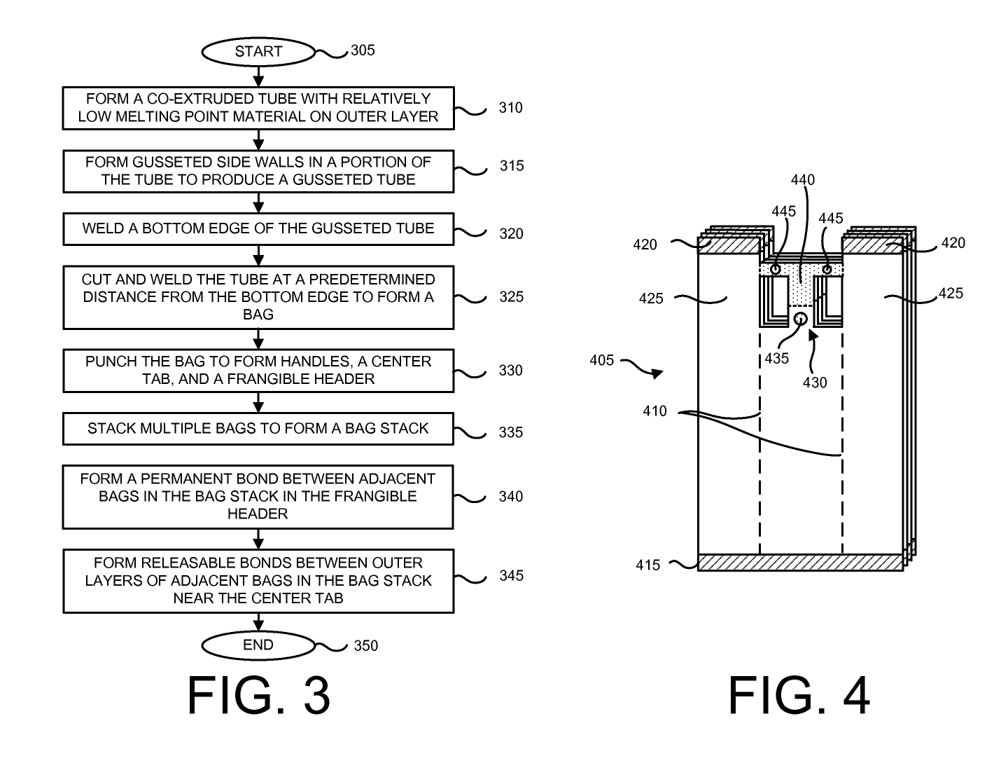

FIG. 3 is a flow diagram of a bag stack manufacturing process, according to an embodiment of the invention. FIG. 4 is a perspective view of a bag stack, according to an embodiment of the invention. With reference to FIGS. 3 and 4, the process begins in step 305 and then forms a co-extruded tube with relatively low melting point material on an outer layer of the tube in step 310. Next, the process forms gusseted side walls in a portion of the tube to produce a gusseted tube in step 315. The process then welds a bottom edge of the gusseted tube in step 320 to form a bottom seal 415. In step 325, the process cuts and welds the tube at a predetermined distance from the bottom edge to form a bag. In step 330, the process punches the bag to form handles 425, a center tab 430, and a frangible header 440. Step 330 may also punch tooling holes in the frangible header 440 to facilitate stacking. In step 335, the process stacks multiple bags to form a bag stack 405. Step 335 may be accomplished, for example using a wicketer. In step 340, the process forms a permanent bond between adjacent bags in the bag stack in the frangible header 440, for instance at locations 445. The process forms releasable bonds between outer layers of adjacent bags in the bag stack, for instance at a location 435 near the center tab 430, in step 345. Step 345 may be or include, for example, thermoplastic welding. The heat applied in step 345 is sufficient to form the releasable bonds between adjacent layers of relatively low melting temperature material in the co-extruded film, but is not sufficient to form a bond between adjacent layers of relatively high melting temperature material. The process terminates in step 350.

FIG. 4 shows a portion of the top weld 420 from step 325 that was not removed during punch step 330. FIG. 4 also illustrates that the side gussets 410 preferably span the width of the handles 425 so that each handle 425 is essentially a loop of 2-ply thermoplastic for increased strength.

Variations to the manufacturing process illustrated in FIG. 3 and the resulting bag stack 405 shown in FIG. 4 are possible. For instance, releasable bonds may also be desirable in bags that do not include gussets. In one embodiment, the cut and weld of cut/weld step 325 could be performed simultaneously. In an alternative embodiment, the cut/weld step 325 could include separate cut and weld steps, and the order of cutting and welding could be varied according to design choice. In addition, alternative embodiments may perform stacking step 335 prior to punching step 330, according to known bag stack manufacturing methods.

### Sheet Stack Manufacturing

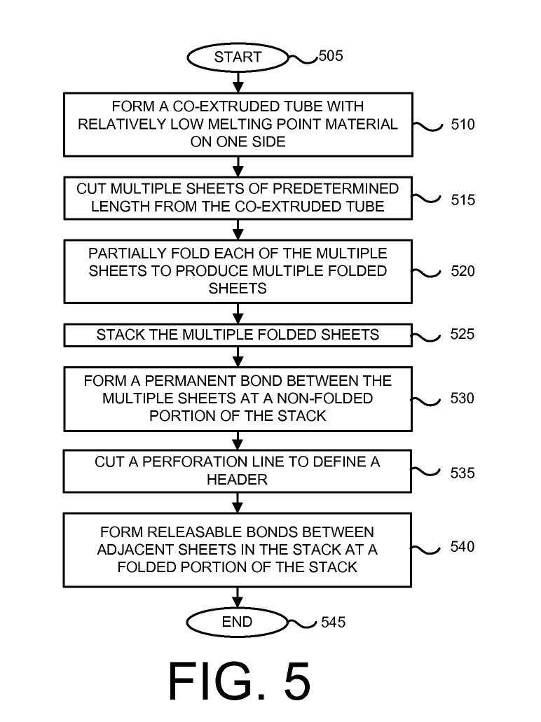

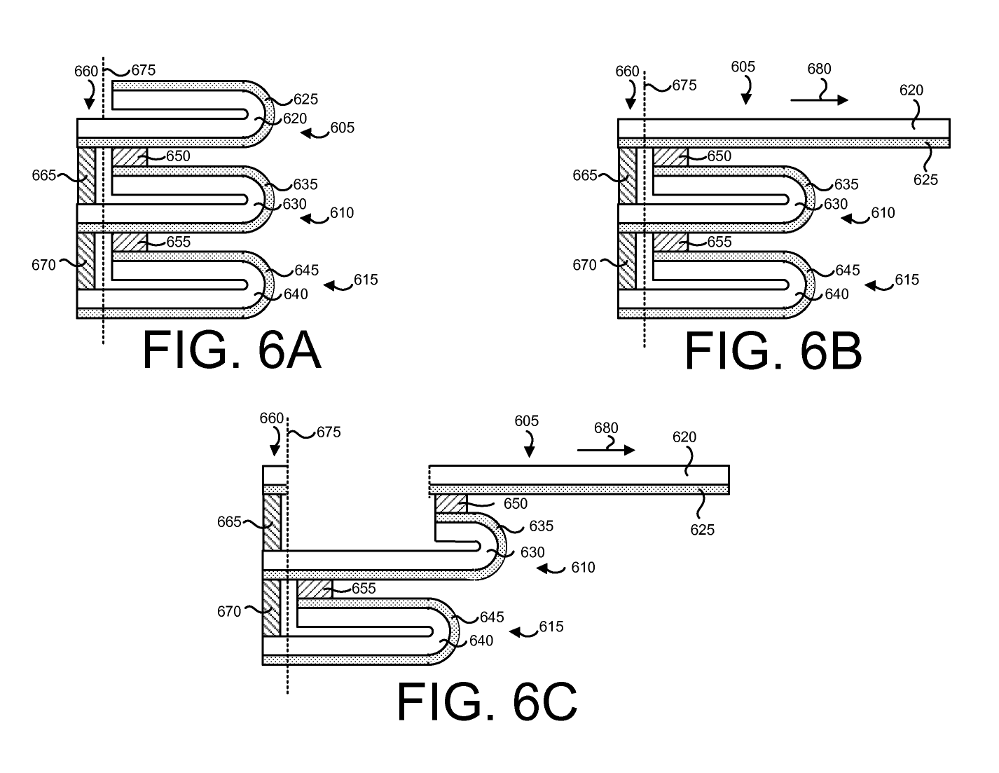

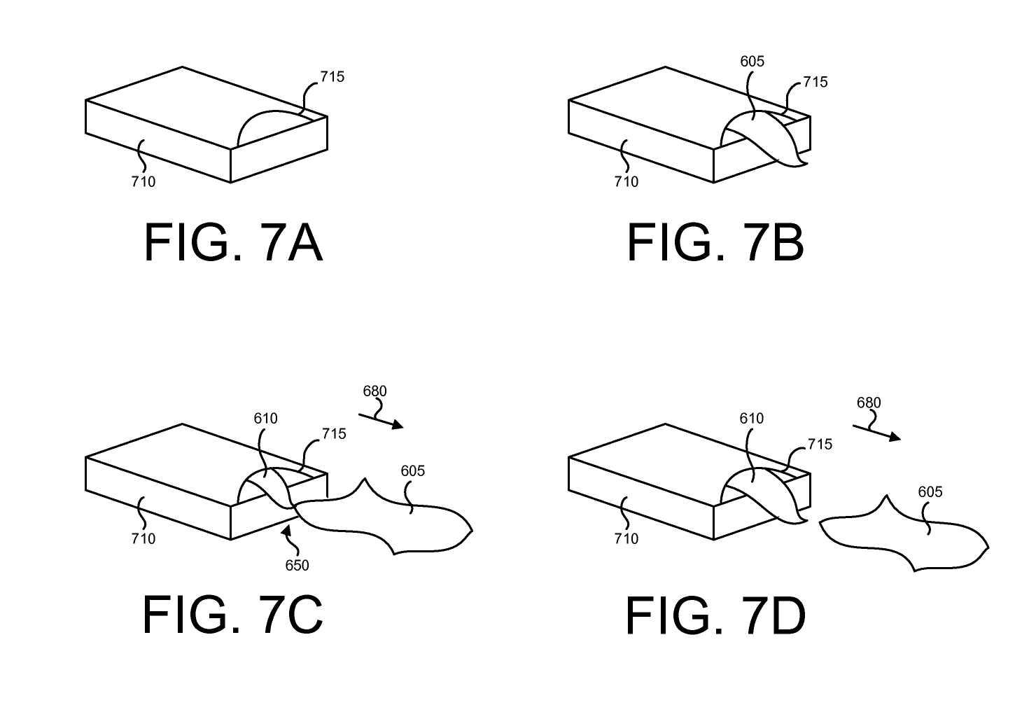

The ability to more easily form releasable plastic bonds can also be beneficial for manufacturing a stack of dispensable plastic sheets (such as a deli sheet product). FIG. 5 provides a manufacturing process for such a product. FIGS. 6A-6C and 7A-7D illustrate additional product features, as well as an end-user dispensing operation.

FIG. 5 is a flow diagram of a sheet stack manufacturing process, according to an embodiment of the invention. With reference to FIG. 5, the manufacturing process begins in step 505 and then forms a co-extruded sheet with relatively low melting point material on one layer in step 510. Step 510 may be executed, for instance, using any of the alternative co-extrusion processes described above with reference to FIG. 1A, 1B, 2A or 2B. Next, in step 515, the process cuts multiple sheets of predetermined length from the co-extruded tube. In step 520, the process folds each of the multiple sheets, for instance about a short dimension, except for a portion of each sheet at a header end. The process then stacks the multiple folded sheets in step 525. The orientation of each sheet in the stack is such that the relatively low melting temperature layers are adjacent to each other. The process then welds the stack of multiple folded sheets at a non-folded (header) portion to form permanent bonds in step 530. Next, the process cuts a perforation line to define a header dimension in step 535. The process then welds the stack of multiple folded sheets at a folded portion to form releasable bonds between adjacent sheets in the stack in step 540. The heat applied in step 540 is sufficient to form the releasable bonds between adjacent layers of relatively low melting temperature material in the co-extruded film, but is not sufficient to form a bond between adjacent layers of relatively high melting temperature material. The process terminates in step 545.

Variations to the manufacturing process illustrated in FIG. 5 are possible. For example, instead of partially folding multiple sheets in step 520 and then stacking the multiple folded sheets in step 525, each sheet could be folded and then added to the stack individually. The sequence of welding step 530, cutting step 535, and welding step 540 could be changed, according to design choice. The manufacturing process could also include disposing the sheet stack in a dispensing container, as illustrated in FIG. 7A.

FIGS. 6A-6C are side sectional views of a sheet stack, according to an embodiment of the invention. FIGS. 6A-6C illustrate three sheets 605, 610, and 615. Each sheet is co-extruded to produce two layers. Sheet 605 includes a first layer 620 with a relatively high melting point and a second layer 625 with a relatively low melting point. Likewise, sheet 610 includes a first layer 630 with a relatively high melting point and a second layer 635 with a relatively low melting point. Sheet 615 includes a first layer 640 with a relatively high melting point and a second layer 645 with a relatively low melting point.

In FIG. 6A, sheets 605, 610 and 615 are shown partially folded and stacked, the result of the manufacturing process described above with reference to FIG. 5. Permanent bonds 665 and 670 affix adjacent sheets in the stack at the header area 660, which is defined by the perforation line 675. Releasable bonds 650 and 655 bond adjacent sheets between the second (relatively low melting point) layers of each co-extruded sheet. Note that adjacent layers of the relatively high melting point layers are not bonded in the folded portion. For example, in sheet 610, a first portion of layer 630 is not bonded to a second portion of layer 630 in the proximity of releasable bonds 650 and 655. The reason for this is that the temperature used in step 345 is not sufficient to melt the relatively high melting point material of layer 630. FIGS. 6B and 6C illustrate a portion of an end-user dispensing operation. In FIG. 6B, a user has extended sheet 605 in a direction 680 away from the header 660. In FIG. 6C, the user has further extended sheet 605 in direction 680. This action has caused the separation of sheet 605 from the header 660 at the perforation line 675, and has also caused partial extension of sheet 610.

FIGS. 7A-7D are perspective views of a dispensing container for a sheet stack, according to an embodiment of the invention. In one respect, FIGS. 7A-7D illustrate that a manufactured sheet stack may be disposed in a dispenser 710 that includes an opening 715. The dispenser 710 could be rigid or soft, and the size and shape of the opening 715 could vary, according to design choice. In another respect, FIGS. 7A-7D illustrate a portion of an end-user dispensing operation. FIG. 7A is a view prior to dispensing, where a sheet stack (not visible) is disposed inside the dispenser 710. In FIG. 7B, a user has extended sheet 605 in a direction 680 from the header 660 and partially through the opening 715. In FIG. 7C, the user has removed the sheet 605 from the dispenser 710. Because of releasable bond 650, this action has also extended sheet 610 in the direction 680. In FIG. 7D, a user has fully separated sheet 605 from the sheet stack.

### SUMMARY

Embodiments of the invention thus provide an improvement in the composition of co-extruded plastic materials. The improved materials can utilize known manufacturing equipment, reduce material costs, and improve the repeatability of manufacturing steps that produce releasable plastic bonds. Embodiments of the invention also provide manufacturing processes for a bag stack and a sheet stack that exploit the releasable bond feature.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

I claim:

1. A method for manufacturing, comprising:
receiving a first polymer and a second polymer, the first polymer having a relatively high melting point, the second polymer having a relatively low melting point; and
co-extruding the first polymer with the second polymer to produce a blown film tube, the first polymer being on an inner layer of the blown film tube, the second polymer being on an outer layer of the blown film tube, the inner layer being relatively thick, the outer layer being relatively thin, the blown film tube enabling the formation of releasable bonds between adjacent outer layers without forming bonds between adjacent inner layers during subsequent manufacturing.

2. The method of claim 1, wherein the melting point of the first polymer is greater than 250 deg. F. and the melting point of the second polymer is less than 200 deg. F.

3. The method of claim 1, wherein the inner layer is five times as thick as the outer layer.

4. The method of claim 1, wherein the first polymer is high-density polyethylene (HDPE).

5. The method of claim 4, wherein the second polymer is a blend of linear low density polyethylene (LLDPE) and polyolefin plastomer (POP).

6. The method of claim 4, wherein the second polymer is a blend HDPE and polyolefin plastomer (POP).

7. The method of claim 4, wherein the second polymer is ethylene vinyl acetate (EVA).

8. The method of claim 4, wherein the second polymer is ethylene methyl acrylate (EMA).

9. The method of claim 1, wherein the first polymer is a blend of high-density polyethylene (HDPE) and linear low density polyethylene (LLDPE).

10. The method of claim 9, wherein the second polymer is ethylene vinyl acetate (EVA).

11. The method of claim 9, wherein the second polymer is ethylene methyl acrylate (EMA).

12. The method of claim 9, wherein the second polymer is a blend HDPE and polyolefin plastomer (POP).

13. The method of claim 9, wherein the second polymer is a blend LLDPE and polyolefin plastomer (POP).

14. The method of claim 1, further comprising:
cutting a plurality of sheets from the blown film tube;
partially folding each of the plurality of sheets to produce a corresponding plurality of partially folded sheets, each of the plurality of partially folded sheets having the second polymer on a top surface and a bottom surface;
stacking the plurality of partially folded sheets to produce a sheet stack; and
welding the sheet stack to produce a releasable bond between adjacent layers of the second polymer in the sheet stack without producing a bond between adjacent layers of the first polymer in the sheet stack.

15. The method of claim 14, further comprising forming a permanent bond between each of the plurality of partially folded sheets in the sheet stack at a portion of each of the plurality partially folded sheets that is not folded, the permanent bond being disposed in a header portion of the sheet stack.

16. The method of claim 14, further comprising cutting a perforation line at a non-folded portion of each of the plurality of partially folded sheets, the perforation line defining a header portion of the sheet stack.

17. The method of claim 14, further comprising disposing the sheet stack in a dispensing container, the dispensing container having an opening, the dispending container to individually dispense each of the plurality of sheets through the opening via a dispensing process.

18. The method of claim 17, the dispensing process including the step of:
unfolding a first one of the plurality of partially folded sheets; and
extending the first one of the plurality of partially folded sheets through the opening, the extending causing the first one of the plurality of partially folded sheets to separate from a sheet stack header and at least partially unfold a second one of the plurality of partially folded sheets.

19. The method of claim 1, further comprising:
forming a plurality of bags from the blown film tube;
stacking the plurality of bags to form a bag stack; and
forming welded releasable bonds between the adjacent outer layers in the bag stack.

20. The method of claim 19, further comprising forming a permanent bond between adjacent bags in the bag stack in a header area.
